(19) United States
(12) Patent Application Publication
(10) Pub. No.: US 2011/0101278 A1
(43) Pub. Date: May 5, 2011

(54) USE OF A CATALYST BASED ON NOBLE METAL FOR REDUCING THE TAR CONTENT IN GASES RESULTING FROM GASIFICATION PROCESSES

(75) Inventors: Georg Anfang, Schechen (DE); Norbert Modl, Bad Aibling (DE)

(73) Assignee: SÜD-CHEMIE AG, Muenchen (DE)

(21) Appl. No.: 12/989,655

(22) PCT Filed: Apr. 15, 2009
(86) PCT No.: PCT/EP2009/054429

§ 371 Date: Dec. 7, 2010

(30) Foreign Application Priority Data
Apr. 28, 2008 (DE) 10 2008 021 084.6

(51) Int. Cl. C01B 3/00; B01D 53/44

(52) U.S. Cl. 252/373; 423/245.1

(57) ABSTRACT

The invention relates to a method for reducing the tar content in gases resulting from a thermochemical gasification process of carbon-containing starting material and includes contacting of at least a part of the gas obtained from the gasification process with a catalyst containing noble metals, wherein the noble metals include at least two noble metals selected from the group consisting of Pt, Pd, Rh, Ir, Os, Ru and Re.

The invention relates to a method for the catalytic reduction of the tar content in gases from gasification processes.

The invention also relates to the use of a catalyst based on noble metal for the reduction of the tar content in gases from gasification processes.

By a gasification process is meant within the framework of the present invention in particular the thermochemical gasification of carbon-containing starting materials. Biomass gasification processes are preferably to be understood by this. The fuel gases produced in the gasifier can be used to generate electricity by means of combustion engines (e.g. gas engines) or in fuel cells. In addition, it is possible to use the produced fuel gases as synthesis gas for the synthesis of liquid fuels such as e.g. methanol, diesel or petrol.

Tar is mostly produced as an unwanted by-product in thermochemical gasification processes and is a complex mixture of organic compounds. Mixtures of cyclic and polycyclic aromatic hydrocarbons are meant by tar within the framework of the present invention. In particular, these compounds have a molecular weight of more than about 78 g/mol (molecular weight of benzene).

Thus different temperature- and process-dependent quantities of gases, tars and coke form for example during the gasification of biomass. The quantity and the precise composition of the tar compounds depend above all on the biomass used, the gasification conditions and the gasifier type. DE102004024672A1 for example describes the relationship in gas production in fixed-bed gasifiers. A distinction is drawn between two basic principles. Although counter-current gasification is technically comparatively simple, it produces combustible useful gases with extremely high tar contents. Although useful gases with a lower tar content can be produced with the technically more demanding co-current gasification, the upscaling of these units is correspondingly more difficult. Tars are also produced with other gasifier types such as e.g. with fluidized-bed gasifiers. The tar content in the raw gas can vary for example between 1 and 100 g/m³ (Devi L., Nair S. A., Pemen A. J. M. et al., Tar Removal from Biomass Gasification Processes, Biomass and Bioenergy: New Research, 2006, pp. 249-274).

Below 300 to 400° C., most tars are present in condensed or resublimated form. Problems are thereby caused by coking and condensation on the different material and/or catalyst surfaces.

It is therefore necessary to reduce the tar content in gases obtained by gasification processes. A further use of the obtained gases, for example as synthesis gas or in fuel cells, can thereby be made possible.

The removal of tar from gases obtained by gasification processes can basically be categorized into primary and secondary measures. Techniques which are already used during the gasification are called primary measures. Secondary measures are downstream of the gasifier. Both processes are based on physical or chemical methods.

Scrubbers or ceramic filters are used for example in physical tar removal. These methods are, however, mostly energy-intensive and require the installation of additional equipment.

By chemical tar removal is meant above all thermal cracking or catalytic conversion of the tars. In thermal cracking, very high temperatures of at least 1000° C. are necessary. Jess, A. (1996) describes, in “Mechanisms and kinetics of thermal reactions of aromatic hydrocarbons from pyrolysis of solid fuels”, Fuel 75, 1441-1448, that a complete conversion of naphthalene-like molecules actually first occurs at temperatures of 1400° C. Neeft, J. P. A., Knowef, H. A. M., Onaji, P. (1999) point out, in “Behaviour of tar in biomass gasification systems. Tar related problems and their solutions.” Novem, The Netherlands, Report No. 9919, that soot can be produced as a consequence of the high temperatures. The main problem with thermal cracking, however, is the increased energy consumption and the associated loss of efficiency of a gasification unit.

In catalytic tar removal, the tar is converted by means of a catalyst at e.g. 800° C. to 900° C. and destroyed. The catalyst can be used directly in the gasification reactor or in a downstream external reactor. Suitable catalysts are for example non-metal catalysts such as dolomites, zeolites and calcite. Suitable metal catalysts are based on Ni, Ni/Mo, Ni/Co/Mo, NiO, Pt or Ru (Corella, Jose, Orio, Alberto and Aznar, Pilar, Biomass Gasification with Air in Fluidized Bed: Reforming of the Gas Composition with Commercial Steam Reforming Catalysts, Ind. Eng. Chem. Res., 1998, 4617-4624; Corella, Jose, Orio, Alberto and Toledo, Jose-Manuel., Biomass Gasification with Air in a Fluidized Bed: Exhaustive Tar Elimination with Commercial Steam Reforming Catalysts, Energy Fuels, 1999, 702-709; Corella, J., Caballero, M. A., Aznar, M. P. and Gil, J., Biomass gasification with air in fluidized bed: hot gas cleanup and upgrading with steam-reforming catalysts of big size, 1999, 933-938; Caballero, Miguel A., Corella, Jose, Aznar, Maria-Pilar and Gil, Javier., Biomass Gasification with Air in Fluidized Bed. Hot Gas Cleanup with Selected Commercial and Full-Size Nickel-Based Catalysts, 2000, 1143-1154; Delgado, Jesus, Aznar, Maria P. and Corella, Jose., Biomass Gasification with Steam in Fluidized Bed: Effectiveness of CaO, MgO, and CaO—MgO for Hot Raw Gas Cleaning, Ind. Eng. Chem. Res., 1997, 1535-1543; Delgado, Jesus, Aznar, Maria P. and Corella, Jose., Calcined Dolomite, Magnesite, and Calcite for Cleaning Hot Gas from a Fluidized Bed Biomass Gasifier with Steam: Life and Usefulness, Ind. Eng. Chem. Res., 1996, 3637-3643).

These catalysts have the advantage that they are capable of also destroying, in addition to tar, the ammonia contained in the product gas. However, the life of these catalysts, in particular in biomass gasification, is not yet sufficient. Furthermore, they are sensitive to sulphur and quickly tend to become deactivated due to coking, in particular if the gases to be cleaned have high tar concentrations (>2 g/m³_{N}).

WO 2007/116121 A1 describes a method of reforming gas containing tarry impurities. Firstly, oxygen is added to the gas. Then this mixture is brought into contact with a solid catalyst, wherein the actual reformation takes place in a two-stage process, in which the gas mixture is brought into contact in a first stage with a zirconium-based catalyst and in a second stage with a metal catalyst consisting of metallic nickel or a noble metal such as Pt, Pd, Rh or Ru.

It is desirable to provide a simplified method for the catalytic reduction of the tar content in gases from gasification processes.

The object of the present invention is to provide a method for the catalytic reduction of the tar content in gases from gasification processes.

This object is achieved according to the invention by a method, comprising bringing at least some of the gas obtained from a gasification process into contact with a noble metal-containing catalyst, applied for example to bulk material or to monolith structure, wherein the noble metal-containing catalyst comprises at least two different noble metals selected from the group consisting of Pt, Pd, Rh, Ir, Os, Ru and Re. The noble metals are also called active components in the following.

It was surprisingly found that, when using a catalyst which contains at least two different noble metal components, very good results are obtained with regard to the reduction of the tar content of gases from gasification processes. Furthermore, the catalysts to be used in the method according to the invention are characterized by a high tolerance vis-à-vis hydrogen sulphide, which is often present as a further impurity in the gases to be treated.

The catalyst that can be used according to the invention preferably comprises two noble metals, wherein catalysts which contain 3 or 4 different noble metals can also be used within the framework of the invention. The catalyst preferably comprises a combination of Pt and Rh or Pt and Ir, the catalyst particularly preferably contains Pt and Rh. The ratio of the at least two noble metal components can be selected as required. If catalysts which contain two noble metals, such as for example Pt and Rh, are used, a weight ratio of from 1:10 to 10:1, preferably 1:1 to 10:1, is preferably used. Catalysts which contain Pt and Rh in a weight ratio of from 1:1 to 6:1, preferably 2:1 to 4:1, are particularly preferably used. Furthermore, catalysts which contain Pt and Ir in a weight ratio of from 1:1 to 6:1, preferably 2:1 to 4:1, are preferred.

Ni which is doped with at least two noble metals, preferably with platinum and rhodium, or platinum and ruthenium, is likewise suitable as active component. An Ni to noble metal weight ratio of from 5:1 to 20:1 is preferably used, particularly preferably from 7:1 to 13:1.

The catalyst can have further constituents, such as promoters for the active components such as e.g. cerium oxide.

The noble metals can be applied directly to bulk material, e.g. to simple α-Al₂O₃ supports or other high temperature-stable supports such as calcium aluminate, hexaaluminates, or similar ceramic support systems which have for example previously been shaped into spheres, tablets, extrudates, trilobes or other shapes. Both Al₂O₃ and other oxides such as Ce oxides, Zr oxides, Ti oxides, La oxides as well as mixtures of the oxides and optionally additional promoters are conceivable. The penetration depth and the concentration of the catalytically active noble metals on the support can be controlled via the concentration and temperature of the impregnating solution, the porosity of the support and the impregnation process itself.

The catalyst according to the invention can be prepared by impregnating a support with an aqueous solution of salts of the desired noble metal. The impregnated catalyst is then dried and calcined, these steps optionally being repeated once or more often.

In addition, so-called supported catalysts can be prepared in which the catalytically active components are applied in highly dispersed form to support materials. For this purpose, support materials are used which have a large specific surface area for receiving the catalytically active components. These are fine-particled, i.e. powdery, temperature-stable metal oxides—called washcoat in the following. Typical washcoat main constituents are aluminium oxides, cerium oxides, zirconium oxides and other metal oxides. Additional promoters for the stabilization of the high surface areas or for the suppression or promotion of secondary reactions can also be present. Aluminium oxides with BET surface areas of from about 50 to about 250 m²/g are typically used.

The support materials are applied in the form of a coating to inert supports—so-called honeycomb bodies—of ceramic (e.g. cordierite) or metal. To coat the honeycomb bodies with the support materials, the support materials are for example dispersed in water and for example homogenized by a grinding process. The walls of the honeycomb bodies are then coated by single or multiple immersion in the coating dispersion, followed by drying and calcining. In this procedure, the catalytically active components can be applied to the specific surface of the support materials at different times. For example, the catalytically active components can be deposited on the support materials only after coating the honeycomb bodies with the dispersion coating by immersion of the coated honeycomb bodies in an aqueous solution of soluble precursors of the catalytically active components. Alternatively, the catalytically active components can be applied to the powdery support materials in a work step upstream of the production of the dispersion coating.

In a preferred embodiment, the active components are applied to support materials comprising a mixed oxide comprising cerium oxide (CeOₓ), lanthanum oxide (La₂O₃), aluminium oxide (Al₂O₃), yttrium oxide (Y₂O₃), titanium oxide (TiO₂), zirconium oxide (ZrO₂), silicon oxide (SiO₂) or mixtures thereof. The support material mixed oxide can be prepared e.g. by impregnating aluminium oxide with the nitrate salts of the respective other metals and subsequent calcining.

The support material is coated beforehand, as described, e.g. onto monolithic cordierite honeycombs, dried and calcined; in one or more further impregnating, drying and calcining steps, the active components are deposited on it. The monolithic supports with honeycomb structure are known to a person skilled in the art and are used e.g. in the automotive industry. Examples of different monolithic supports are described in Handbook of Heterogeneous Catalysis 4—Environmental Catalysis, pages 1575-1583. Other suitable methods for applying the active components to the supports are impregnating, spraying, ion exchange, immersion and all other techniques described in the literature.

The catalysts to be used within the framework of the invention tolerate sulphur compounds, which are mostly contained in the gas to be cleaned up, i.e. although the activity of the catalyst is lower compared with a gas stream without sulphur, complete deactivation does not occur.

The gas to be treated within the framework of the method according to the invention usually comprises, as main components, carbon monoxide, carbon dioxide, methane, hydrogen, water vapour and nitrogen. It also contains tar compounds and typically also small quantities of further impurities such as for example ammonia or hydrogen sulphide. Water vapour, oxygen or other oxygen-containing gases such as e.g. air can serve as gasification medium in the gasification process. Depending on the gasification method used, certain quantities of the gasification medium can also be present in the gas to be treated.

The method according to the invention is carried out between the process steps of the fuel gas production (thermochemical gasification) and the fuel gas use (e.g. gas engine, gas turbine, fuel cell, inter alia) in the form of a method step in which the tar compounds are removed from the gas as far as possible. Optionally, dust- and/or carbon-containing solids can be separated from the gas before the catalytic tar removal step, for example by physical separation methods such as cyclones, filters, scrubbers, deflectors or the like and/or other impurities such as e.g. sulphur compounds separated after cooling the gas after the catalyst for example by adsorptive separation of the main sulphur component H₂S on ZnO CuO/ZnO or activated carbon. Furthermore, before at least some of the gas obtained from the gasification process is brought directly into contact with the above-described noble metal-containing catalyst which contains at least two noble metals, an oxygen enrichment of the gas, as described in WO 2007/116121 A1, can optionally be carried out. If no dust removal is carried out before the catalytic tar removal step, relatively coarse honeycomb bodies (with e.g. 100 cpsi (cells per square inch) instead of 400 cpsi) are preferably used, in order to prevent caking of the honeycomb entry and the honeycomb channels.

According to the method according to the invention, the gas to be treated can be brought into contact with the noble metal-containing catalyst either directly in the gasification reactor or in an external reactor. Within the framework of the invention, at least some of the gas obtained from a gasification process is brought into contact with the noble metal-containing catalyst. Contact is established in particular by passing the gas stream through or over the catalyst. According to a preferred embodiment, all the gas obtained from a gasification process is treated according to the method according to the invention.

In the presence of the catalytic surfaces, the tar compounds are split into smaller molecules by chemical reaction with other gas constituents. The tars formed in the gasification reactor are chemically transformed, i.e. catalytically reformed, into the useful gases CO and H₂ according to the reaction equations below (equations 1 and 2). CₙHₘ represents tarry compounds. If oxygen is still contained in the gas (e.g. from the gasification medium or also by separate addition), partial (3) or total (4) oxidation reactions can also occur:

CₙHₘ+nH₂O [symbol] nCO+(n+m/2)H₂ (1)

CₙHₘ+nCO₂ [symbol] 2nCO+(m/2)H₂ (2)

CₙHₘ+n/2O₂ [symbol] nCO+m/2H₂ (3)

CₙHₘ+(n+m/4)O₂ [symbol] nCO₂+m/2H₂O (4)

The method according to the invention has a high yield, thus a high tar clean-up rate, preferably in the range from 60-100%, in particular 70 to 90%. Furthermore, the catalysts are high-temperature stable (up to 1000° C.); the method can therefore be used directly after the gasification without cooling the synthesis gas. Because of the high activity of the catalysts, the method according to the invention can also be performed at a lower temperature level. The method is preferably carried out at 500-1000° C., particularly preferably at 600° C.-800° C. and quite particularly preferably at 650° C.-850° C. In the method according to the invention, space velocities (total (wet) SV) of from 1000 to 10000 volumetric flow/volume cat. are preferably used, still more preferably in the range from 3000 to 6000 and particularly preferably from 2000 to 5000.

Part of the invention is furthermore the use of a noble metal-containing catalyst comprising at least two noble metals selected from the group consisting of Pt, Pd, Rh, Ir, Os, Ru and Re for the reduction of the tar content in gases from gasification processes of carbon-containing starting materials. With regard to the advantageous embodiments of the use according to the invention, reference is made to the above statements in connection with the method according to the invention. In addition, a subject of the invention is a method for the preparation of synthesis gas with reduced tar content using a noble metal-containing catalyst as described above.

The invention is described in more detail using the following examples, without being limited by them.

### PREPARATION EXAMPLE 1

### Support Material

A mixed oxide powder consisting of 3% La₂O₃, 17% CeO₂, and 80% Al₂O₃, based on wt.-%, is suspended in DEMI H₂O, then stirred for 10 min and set to a pH of 4.5 with 99% acetic acid. The suspension is set to a solids content of approx. 40%. The suspension is stirred and ground repeatedly in a Dyna Mill ball mill, until a particle size composition of d50<10 μm is achieved.

### PREPARATION EXAMPLE 8

### Catalyst

A cylindrical honeycomb body of cordierite with a 400-cpsi cross-section surface is repeatedly immersed in the suspension from preparation example 1, blown dry at 120° C. and then calcined for 3 h at 850° C. in air, until the honeycomb body has a charge of 100 g mixed oxide per litre of honeycomb volume. The coated catalyst support is then immersed in an aqueous solution of Rh(NO₃)₃. The honeycomb body impregnated with the noble-metal salt solution is dried and calcined at 550° C. in air. The impregnation process is carried out such that the catalyst support takes up 0.5 g rhodium per litre of honeycomb volume. The coated catalyst support is then immersed in an aqueous solution of [Pt(NH₃)₄](OH)₂. The honeycomb body impregnated with the noble-metal salt solution is dried and calcined at 550° C. in air. The impregnation process is carried out, and optionally repeated several times, such that the catalyst support takes up 1 g platinum per litre of honeycomb volume. The final concentration of noble metals is 0.5 g/L Rh and 1 g/L Pt.

### PREPARATION EXAMPLE 9

### Catalyst

A cylindrical honeycomb body of cordierite with a 400-cpsi cross-section surface is repeatedly immersed in the suspension from preparation example 1, blown dry at 120° C. and then calcined for 3 h at 850° C. in air, until the honeycomb body has a charge of 100 g mixed oxide per litre of honeycomb volume. The coated catalyst support is then immersed in an aqueous solution of Rh(NO₃)₃. The honeycomb body impregnated with the noble-metal salt solution is dried and calcined at 550° C. in air. The impregnation process is carried out such that the catalyst support takes up 0.5 g rhodium per litre of honeycomb volume. The coated catalyst support is then immersed in an aqueous solution of [Pt(NH₃)₄](OH)₂. The honeycomb body impregnated with the noble-metal salt solution is dried and calcined at 550° C. in air. The impregnation process is carried out, and optionally repeated several times, such that the catalyst support takes up 2 g platinum per litre of honeycomb volume. The final concentration of noble metals is 0.5 g/L Rh and 2 g/L Pt.

### PREPARATION EXAMPLE 10

### Catalyst

A cylindrical honeycomb body of cordierite with a 400-cpsi cross-section surface is repeatedly immersed in the suspension from preparation example 1, blown dry at 120° C. and then calcined for 3 h at 850° C. in air, until the honeycomb body has a charge of 100 g mixed oxide per litre of honeycomb volume. The coated catalyst support is then immersed in an aqueous solution of Rh(NO₃)₃. The honeycomb body impregnated with the noble-metal salt solution is dried and calcined at 550° C. in air. The impregnation process is carried out such that the catalyst support takes up 1 g rhodium per litre of honeycomb volume. The coated catalyst support is then immersed in an aqueous solution of [Pt(NH₃)₄](OH)₂. The honeycomb body impregnated with the noble-metal salt solution is dried and calcined at 550° C. in air. The impregnation process is carried out, and optionally repeated several times, such that the catalyst support takes up 4 g platinum per litre of honeycomb volume. The final concentration of noble metals is 1 g/L Rh and 4 g/L Pt.

### PREPARATION EXAMPLE 11

### Catalyst

A cylindrical honeycomb body of cordierite with a 400-cpsi cross-section surface is repeatedly immersed in the suspension from preparation example 1, blown dry at 120° C. and then calcined for 3 h at 850° C. in air, until the honeycomb body has a charge of 100 g mixed oxide per litre of honeycomb volume. The coated catalyst support is then immersed in an aqueous solution of Ni(NO₃)₂. The honeycomb body impregnated with the metal salt solution is dried and calcined at 550° C. in air. The impregnation process is carried out, and optionally repeated several times, such that the catalyst support takes up 10 g nickel per litre of honeycomb volume.

### PREPARATION EXAMPLE 12

### Catalyst

A cylindrical honeycomb body of cordierite with a 400-cpsi cross-section surface is repeatedly immersed in the suspension from preparation example 1, blown dry at 120° C. and then calcined for 3 h at 850° C. in air, until the honeycomb body has a charge of 100 g mixed oxide per litre of honeycomb volume. The coated catalyst support is then immersed in an aqueous solution of Ni(NO₃)₂. The honeycomb body impregnated with the metal salt solution is dried and calcined at 550° C. in air. The impregnation process is carried out, and optionally repeated several times, such that the catalyst support takes up 10 g nickel per litre of honeycomb volume. The coated catalyst support is then immersed in an aqueous solution of Rh(NO₃)₃. The honeycomb body impregnated with the noble-metal salt solution is dried and calcined at 550° C. in air. The impregnation process is carried out such that the catalyst support takes up 0.1 g rhodium per litre of honeycomb volume.

1. Method for the reduction of a tar content in gases from a gasification process from carbon-containing starting materials, comprising bringing gas obtained from a gasification process into contact with a noble metal-containing catalyst, wherein the noble metal-containing catalyst comprises at least two noble metals selected from the group consisting of Pt, Pd, Rh, Ir, Os, Ru and Re.

2. Method according to claim 1, characterized in that the noble metal-containing catalyst comprises Pt and Rh.

3. Method according to claim 1, characterized in that the noble metal-containing catalyst is applied to a support or is present as a bulk material catalyst.

4. Method according to claim 1, characterized in that the noble metal containing catalyst is applied to a support in the form of a honeycomb.

5. Method according to one of claim 3, characterized in that the support is selected from the group consisting of cerium oxide (CeOₓ), lanthanum oxide (La₂O₃), aluminium oxide (AI₂O₃), yttrium oxide (Y₂O₃), titanium oxide (TiO₂), zirconium oxide (ZrO₂), silicon oxide (SiO₂) and mixtures thereof.

6. Method according to claim 1, characterized in that the bringing of the gas into contact with the noble metal-containing catalyst takes place in the gasification reactor or in an external reactor.

7. Method according to claim 1 wherein the gas contacted with the catalyst further comprises tar comprising mixtures of cyclic and polycyclic aromatics.

8. Method according to claim 1, characterized in that the gasification process comprises a biomass gasification process.

9. (canceled)

10. (canceled)

11. (canceled)

12. (canceled)

13. (canceled)

14. Method for the preparation of synthesis gas with reduced tar content using a noble metal-containing catalyst comprising bringing fuel gases obtained from a gasification process into contact with a noble metal-containing catalyst, wherein the noble metal-containing catalyst comprises at least two noble metals selected from the group consisting of Pt, Pd, Rh, Ir, Os, Ru and Re.

15. Method of claim 7 wherein the aromatics have a molecular weight more than about 78 g/mol.

16. Method according to one of claim 4, characterized in that the support is selected from the group consisting of cerium oxide (CeOₓ), lanthanum oxide (La₂O₃), aluminium oxide (AI₂O₃), yttrium oxide (Y₂O₃), titanium oxide (TiO₂), zirconium oxide (ZrO₂), silicon oxide (SiO₂) and mixtures thereof.

17. The method of claim 1 wherein the noble metal-containing catalyst comprises Pt and Ir.

18. The method of claim 2 wherein the weight ratio of Pt to Rh is from 1:10 to 10:1.

19. The method of claim 2 wherein the weight ratio of Pt to Rh is from 1:1 to 6:1.

20. The method of claim 2 wherein the weight ratio of Pt to Rh is from 2:1 to 4:1.

21. The method of claim 17 wherein the weight ratio of Pt to Ir is from 1:1 to 6:1.

22. The method of claim 17 wherein the weight ratio of Pt to Ir is from 2:1 to 4:1.

23. The method of claim 1 further comprising Ni.

24. The method of claim 23 wherein the noble metals are selected from the group consisting of a) platinum and rhodium and b) platinum and ruthenium.

25. The method of claim 24 wherein the weight ratio of Ni to noble metals comprises 5:1 to 20:1.
